(19) United States
(12) Patent Application Publication
(10) Pub. No.: US 2021/0333588 A1
(43) Pub. Date: Oct. 28, 2021

(54) DISPLAY PANEL AND PREPARATION METHOD THEREOF

(71) Applicant: Shenzhen China STAR OPTOELECTONICS SEMICONDUCTOR DISPLAY TECHNOLOGY CO., LTD., Shenzhen, Guangdong (CN)

(72) Inventor: Chunge YUAN, Shenzhen, Guangdong (CN)

(21) Appl. No.: 16/618,778

(22) PCT Filed: Jun. 5, 2019
(86) PCT No.: PCT/CN2019/090093

§ 371 Date: Dec. 2, 2019

(30) Foreign Application Priority Data
May 21, 2019 (CN) 201910422580.6

(51) Int. Cl. G02F 1/1339; G02F 1/1335

(52) U.S. Cl. CPC G02F 1/1339; G02F 1/133516

(57) ABSTRACT

A display panel and a preparation method thereof are provided. The preparation method includes a base substrate arrangement step, a retaining wall forming step, a primary sealant providing step, a liquid crystal layer forming step, a color filter substrate bonding step, a curing step, and a cutting step. The display panel includes an array substrate, a color filter substrate, a liquid crystal layer, and a primary sealant. The technical effect of the invention is that the retaining wall is disposed on the periphery of the primary sealant such that the display panel prevents the primary sealant from being broken by the air flow during the atmosphere introduction step, thereby realizing the preparation of the flexible sealant display panel.

### FIELD OF INVENTION

The present invention relates to the field of display, and in particular to a display panel and a method of preparing the same.

### BACKGROUND OF INVENTION

Due to demands of smart driving, smart home appliances, portable devices, etc, flexible displays have attracted much attention at major exhibitions in recent years and are considered to be an important direction for display development in the future.

Development of flexible display panel technology is characterized by being bendable, curlable, and not easily damaged. In order to achieve flexibility, i.e., the bending property, it is necessary to use a flexible sealant. Because brittleness of the flexible sealant is small, such that when the substrate is folded and bent, the sealant can also be folded and bent without cracking to cause technical problems such as damage of the display panel. Therefore, the sealant can increase surface life of a flexible substrate.

In the TFT-LCD panel, a sealant is required when an array substrate and a color filter substrate are bonded in a cell. Functions of the sealant include a bonding function, the sealant is used to fix the array substrate and the color filter substrate; a sealing function, the sealant is used to prevent liquid crystals from contacting with external moisture and impurities and avoiding the liquid crystals from flowing out; and a support function, the sealant is used to coat a specific seal pattern to support a gap of the seal pattern.

Generally, a sealant is coated on an outer periphery of an overall substrate to support the gap around the overall substrate to prevent an upper substrate and a lower substrate from being attached and resulting in subsequent cutting and fragmentation issues. The primary sealant is applied to a periphery of each of the array substrate and functions as described above. However, due to its characteristics such as bendable and curlable, the flexible sealant is easily damaged by airflow in the subsequent vacuum relief process, causing the liquid crystals to flow out, which leads to a display panel damage.

### Technical Problem

An object of the present invention is to solve the technical problem that the flexible sealant of the current display panel is prone to damage during the preparation process.

### SUMMARY OF INVENTION

To achieve the above object, the present invention provides a method for preparing a display panel, including the following steps: a base substrate arrangement step, forming two or more array substrates on the base substrate; a retaining wall forming step, forming a retaining wall on the base substrate, wherein the retaining wall encircles at least one array substrate; a primary sealant providing step, providing a primary sealant to each of the array substrates to form sealant cavities; a liquid crystal layer forming step, dropping liquid crystals into the sealant cavity of each of the array substrates to form liquid crystal layers encircled by the primary sealant; a color filter substrate bonding step, vacuum bonding a color filter substrate on the liquid crystal layers; a curing step, curing the primary sealant, and a cutting step, cutting the base substrate and removing the retaining wall encircling each of the array substrates to form two or more display panels.

Further, the method of preparing the display panel further including a sealant coating step after the base substrate arrangement step, applying the sealant to a periphery of the base substrate, and the sealant encircling all the array substrates.

Further, the retaining wall forming step includes forming retaining walls at a periphery of each of the array substrates, wherein the retaining wall each encircles each of the array substrates and providing the primary sealant to an inner side of each of the retaining walls.

Further, the retaining wall forming step includes dividing the base substrate into two or more regions and forming the retaining walls at a periphery of each of the regions.

Further, the retaining wall forming step includes forming the retaining wall on a periphery of the base substrate to encircle all of the array substrates.

Further, in the retaining wall forming step, the retaining wall is a non-flexible sealant and the retaining wall includes a spacer or a black matrix.

Further, the color filter substrate bonding step includes: a color filter substrate covering step, covering the liquid crystal layers with the color filter substrate; a vacuuming step, feeding the base substrate into a vacuum chamber and vacuuming the vacuum chamber to bond the color filter substrate to the liquid crystal layers; and an atmosphere introduction step, introducing the atmosphere into the vacuum chamber.

Further, the curing step includes adopting an ultraviolet light curing method and/or a thermal curing method.

In order to achieve the above object, the present invention also provides a display panel prepared by the above-mentioned method.

Further, the display panel includes: an array substrate; a color filter substrate disposed opposite to the array substrate; a liquid crystal layer disposed between the array substrate and the color filter substrate; and a primary sealant disposed between the array substrate and the color filter substrate and encircles the liquid crystal layer.

### Beneficial Effect

The technical effect of the invention is that in a preparation process of the display panel, a retaining wall is disposed on the periphery of the primary sealant to prevent the primary sealant from being damaged during an atmosphere introduction step, thereby avoiding the technical problem of liquid crystal flowing out from the sealant cavity. Thus, the yield of forming the flexible sealant on the display panel is improved and the yield of the display panel is further improved.

### DESCRIPTION OF DRAWINGS

FIG. 1 is a flowchart of a method for preparing the display panel according to embodiment 1 of the present invention.

FIG. 2 is a flowchart of the color filter substrate bonding step according to embodiment 1 of the present invention.

FIG. 3 is a schematic structural view of a display panel after the curing step according to embodiment 1 of the present invention.

FIG. 4 is a plan view of a substrate after the curing step according to embodiment 1 of the present invention.

FIG. 5 is another plan view of a substrate after the curing step according to embodiment 1 of the present invention.

FIG. 6 is a schematic structural view of a display panel after the cutting step according to embodiment 1 or embodiment 2 of the present invention.

FIG. 7 is a plan view of a display panel after the cutting step according to embodiment 1 or embodiment 2 of the present invention.

FIG. 8 is a flowchart of a method for preparing the display panel according to embodiment 2 of the present invention.

FIG. 9 is a flowchart showing a color filter substrate bonding step according to embodiment 2 of the present invention.

FIG. 10 is a plan view of a base substrate after the curing step according to embodiment 2 of the present invention.

The reference numerals of components in the drawings are denoted as follows:
1: array substrate,
2: retaining wall,
3: primary sealant,
4: liquid crystal layer,
5: color filter substrate.

### DETAILED DESCRIPTION OF PREFERRED EMBODIMENTS

The preferred embodiments of the present invention are described in detail following with reference to the accompanying drawings to certify the invention can be implemented and render the disclosed technical content of the invention clearer. Those skilled in the art will more readily understand how to implement the invention. However, the present invention may be embodied in different forms and embodiments, and the scope of the invention is not limited to the embodiments described herein.

The directional terms mentioned in the present invention, such as “upper”, “lower”, “front”, “rear”, “left”, “right”, “inside”, “outside”, “side”, etc., only represent the directions in the drawings. The directional terms used herein are used to explain the invention and are not intended to limit the scope of the invention.

In the drawings, structurally identical components are denoted by the same reference numerals, and structural or functionally similar components are denoted by similar reference numerals. Moreover, the size and thickness of each component shown in the drawings are arbitrarily shown for ease of understanding and description, and the invention does not limit the size and thickness of each component.

When a component is described as “on” the other component, the component may be placed directly on the other component; there may also be an intermediate component, the component is placed on the intermediate component and the intermediate component is placed on the other component. When a component is described as “mounted/connected” to the other component, it may be understood as the component is directly “mounted/connected” to the other component or “mounted/connected” to the other component by an intermediate component.

### Embodiment 1

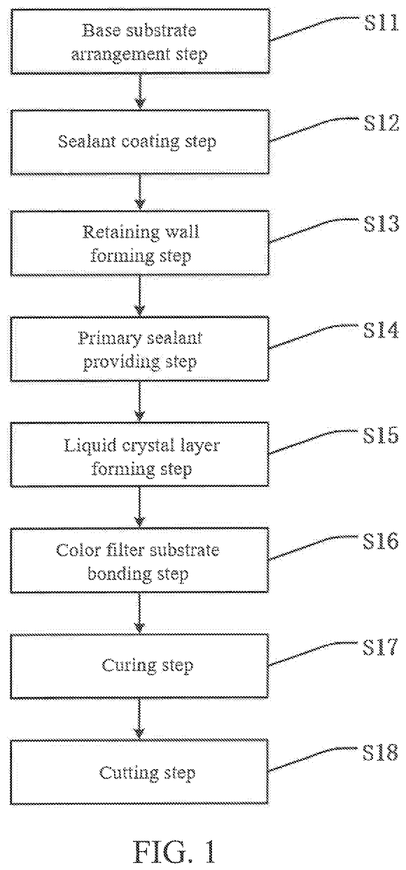

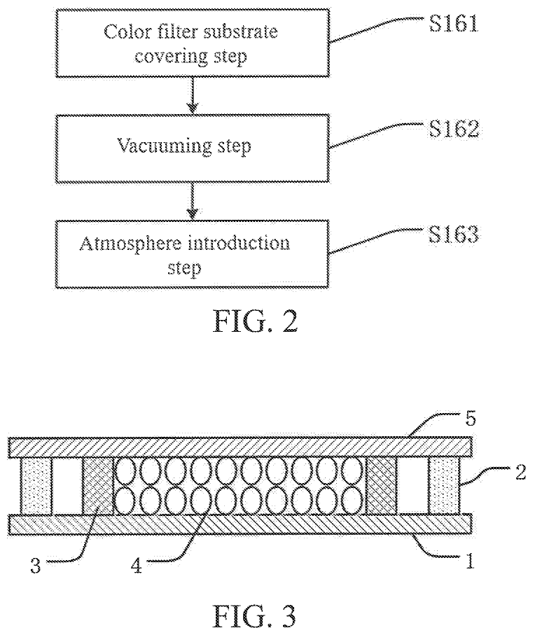

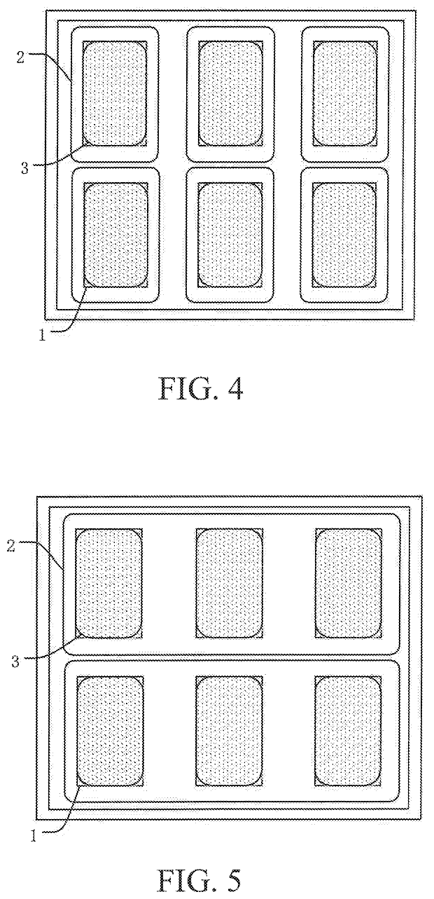

As shown in FIG. 1 to FIG. 7, the embodiment provides a method for preparing a display panel, includes the following steps S11 to S18.

S11: a base substrate arrangement step, two or more array substrates are disposed on one base substrate, and the two or more array substrates are arranged in a matrix.

S12: a sealant coating step, applying a sealant to a periphery of an upper surface of the base substrate, and the sealant encircling all the array substrates on the base substrate. The sealant acts to support the base substrate to prevent an upper substrate and a lower substrate from sticking together during the subsequent bonding process, and avoiding cutting abnormality issues in the subsequent cutting step.

S13: a retaining wall forming step, forming the retaining walls at a periphery of each of the array substrates, the retaining wall made of at least one of a non-flexible sealant, a spacer, and a black matrix. The shape of the retaining wall includes at least one of right-angled rectangle, rounded rectangle, and ellipse. In other embodiments, the base substrate can be divided into a plurality of regions with a retaining wall at the periphery of each region.

S14: a primary sealant providing step, providing a primary sealant to each of the array substrates to form sealant cavities. The material of the primary sealant is a flexible sealant, which meets the requirements of the current flexible display panel. In a display panel preparation process of the prior art, after the flexible sealant is provided, the subsequent vacuum relief and curing, etc., steps are performed, which cause the flexible sealant to be easily destroyed by the atmosphere, and cause an outflow of the liquid crystals in the sealant cavity encircled by the flexible sealant, thereby the display panel is damaged. For this reason, in the embodiment, a non-flexible sealant is applied to the periphery of the flexible sealant to protect the flexible sealant.

S15: a liquid crystal layer forming step, dropping liquid crystals into the sealant cavity of each of the array substrates to form liquid crystal layers each encircled by the primary sealant.

S16: a color filter substrate bonding step, vacuum bonding a color filter substrate on the liquid crystal layers, wherein the color film substrate bonding step specifically includes S161 to S163.

S161: a color filter substrate covering step, covering the liquid crystal layers with the color filter substrate, wherein a size of the color filter substrate needs to be larger than that of the liquid crystal layer to ensure the liquid crystal layers are completely covered to prevent the liquid crystals from flowing out.

S162: a vacuuming step, feeding the base substrate into a vacuum chamber and vacuuming the vacuum chamber to completely bond the color filter substrate to the liquid crystal layers.

S163: an atmosphere introduction step, introducing the atmosphere into the vacuum chamber. In the atmosphere introduction step, due to the barrier protection of the retaining wall, the primary sealant is not affected by the air flow, and the liquid crystals are prevented from flowing out.

S17: a curing step, curing the primary sealant by ultraviolet light curing method or heat curing method. (refer to FIG. 3 to FIG. 5). Each of the array substrates 1 after curing is disposed opposite to the color filter substrate 5. The liquid crystal layer 4 is disposed in the sealant cavity encircled by the primary sealant 3, and the retaining wall 2 encircles the primary sealant 3 to protect the primary sealant 3.

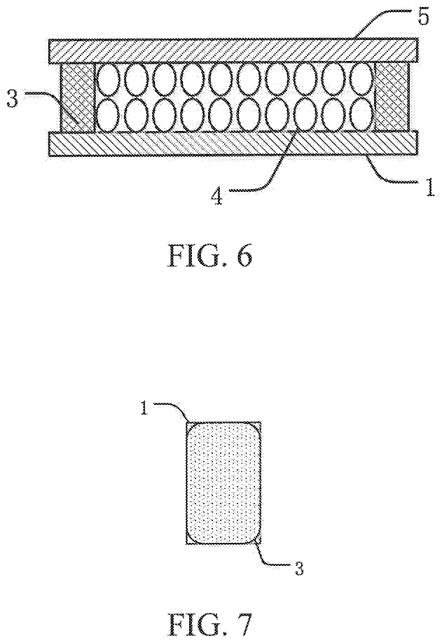

S18: a cutting step, cutting the base substrate and removing the retaining wall encircling each of the array substrates to form two or more display panels. (refer to FIG. 6 to FIG. 7).

As shown in FIG. 6, the embodiment further provides a display panel prepared by the above-mentioned method, including an array substrate 1, a primary sealant 3, a liquid crystal layer 4, and a color filter substrate 5.

The array substrate 1 is disposed opposite to the color filter substrate 5, and the liquid crystal layer 4 is disposed in the sealant cavity encircled by the primary sealant 3.

The technical effect of the embodiment is that in the preparation process of the display panel, the retaining wall is provided on the periphery of the primary sealant to prevent the primary sealant from being broken during the atmosphere introduction step, thereby, avoiding the technical issue that the liquid crystals flowing out from the sealant cavity. Thus, the yield of forming the flexible sealant on the display panel is improved and the yield of the display panel is further improved accordingly.

### Embodiment 2

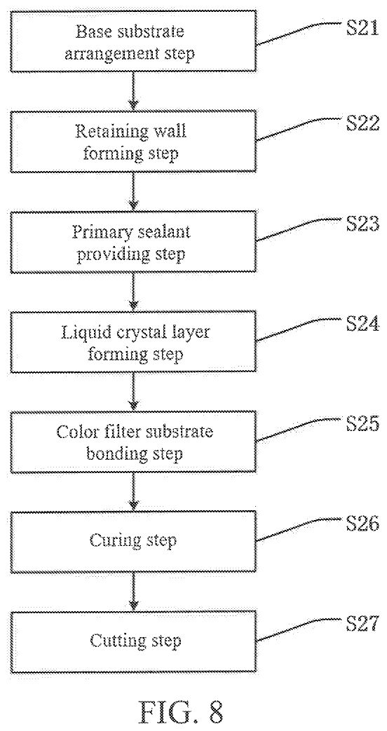

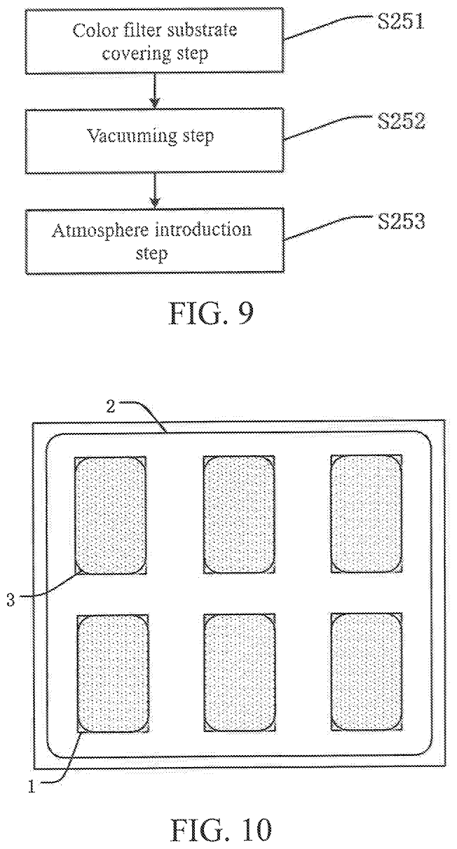

As shown in FIG. 8 to FIG. 10, the embodiment provides a method for preparing a display panel, includes the following steps S21 to S27.

S21: a base substrate arrangement step, two or more array substrates are disposed on one base substrate, and the array substrates are arranged in a matrix.

S22: a retaining wall forming step, forming an encircled retaining wall at a periphery of the base substrate, the retaining wall made of at least one of a non-flexible sealant, a spacer, and a black matrix. The shape of the retaining wall includes at least one of right-angled rectangle, rounded rectangle, and ellipse. The retaining wall also functions a supporting effect to support the base substrate to prevent the upper and lower substrates from sticking together during the subsequent bonding process, thereby avoiding a cutting abnormality issue in the subsequent cutting step.

S23: a primary sealant providing step, providing a primary sealant to each of the array substrates to form a sealant cavity. The material of the primary sealant is a flexible sealant, which meets the requirements of the current flexible display panel. In a display panel preparation process of the prior art, after the flexible sealant is provided, the subsequent vacuum relief and curing, etc., steps are performed, which cause the flexible sealant to be easily destroyed by the atmosphere, and further cause an outflow of the liquid crystals in the sealant cavity encircled by the flexible sealant, thereby the display panel is damaged. For this reason, in the embodiment, a non-flexible sealant is provided on a periphery of the flexible sealant to protect the flexible sealant.

S24: a liquid crystal layer forming step, dropping liquid crystals into the sealant cavity of each of the array substrates to form liquid crystal layers encircled by the primary sealant.

S25: a color filter substrate bonding step, vacuum bonding a color filter substrate on the liquid crystal layers. The color filter substrate bonding step specifically includes S251 to S253.

S251: a color filter substrate covering step, covering the liquid crystal layers with a color filter substrate. A size of the color filter substrate needs to be larger than that of the liquid crystal layer to ensure the liquid crystal layer is completely covered to prevent the liquid crystal from flowing out.

S252: a vacuuming step, feeding the base substrate into a vacuum chamber and vacuuming the vacuum chamber to completely bond the color filter substrate to the liquid crystal layers.

S253: an atmosphere introduction step, introducing the atmosphere into the vacuum chamber. In the atmosphere introduction step, due to the barrier protection of the retaining wall, the primary sealant is not affected by the air flow, such that the liquid crystals are prevented from flowing out.

S26: a curing step, curing the primary sealant by ultraviolet light curing method or heat curing method. (refer to FIG. 10). The cured primary sealant 3 is disposed on each of the array substrates 1, and the retaining wall 2 encircles all the primary sealant 3 to protect the primary sealant 3.

S27: a cutting step, cutting the base substrate and removing the retaining wall to form two or more display panels. (refer to FIG. 6 to FIG. 7).

As shown in FIG. 6, the present embodiment further provides a display panel prepared by the above method, including an array substrate 1, a primary sealant 3, a liquid crystal layer 4, and a color filter substrate 5.

The array substrate 1 is disposed opposite to the color filter substrate 5, and the liquid crystal layer 4 is disposed in the sealant cavity encircled by the primary sealant 3.

The technical effect of the invention is that in the preparation process of the display panel, the retaining wall is provided on the periphery of the primary sealant to prevent the primary sealant from being damaged during the atmosphere introduction step, thereby avoiding the technical problem of liquid crystals flowing out from the sealant cavity. Thus, the yield of forming the flexible sealant in the display panel is improved and yield of the display panel is further improved accordingly.

The description of the above exemplary embodiments is only for the purpose of understanding the invention. It is to be understood that the present invention is not limited to the disclosed exemplary embodiments. It is obvious to those skilled in the art that the above exemplary embodiments may be modified without departing from the scope and spirit of the present invention.

What is claimed is:

1. A method of preparing a display panel, comprising:
a base substrate arrangement step, forming two or more array substrates on the base substrate;
a retaining wall forming step, forming a retaining wall on the base substrate, wherein the retaining wall encircles at least one array substrate;
a primary sealant providing step, providing a primary sealant to each of the array substrates to form sealant cavities;
a liquid crystal layer forming step, dropping liquid crystals into the sealant cavity of each of the array substrates to form liquid crystal layers encircled by the primary sealant;
a color filter substrate bonding step, vacuum bonding a color filter substrate on the liquid crystal layers;
a curing step, curing the primary sealant, and
a cutting step, cutting the base substrate, removing the retaining wall encircling each of the array substrates to form two or more display panels.

2. The method of preparing the display panel according to claim 1, further comprising a sealant coating step after the base substrate arrangement step, applying the sealant to a periphery of the base substrate, the sealant encircling all the array substrates.

3. The method of preparing the display panel according to claim 2, wherein the retaining wall forming step comprises forming the retaining walls at a periphery of each of the array substrates, wherein the retaining wall each encircles each of the array substrates, and providing the primary sealant to an inner side of each of the retaining walls.

4. The method of preparing the display panel according to claim 2, wherein the retaining wall forming step comprises dividing the base substrate into two or more regions and forming the retaining walls at a periphery of each of the regions.

5. The method of preparing the display panel according to claim 1, wherein the retaining wall forming step comprises forming the retaining wall on a periphery of the base substrate to encircle all of the array substrates.

6. The method of preparing the display panel according to claim 1, wherein in the retaining wall forming step, the retaining wall is a non-flexible sealant and the retaining wall comprises a spacer or a black matrix.

7. The method of preparing the display panel according to claim 1, wherein the color filter substrate bonding step comprises:
a color filter substrate covering step, covering the liquid crystal layers with the color filter substrate;
a vacuuming step, feeding the base substrate into a vacuum chamber and vacuuming the vacuum chamber to bond the color filter substrate to the liquid crystal layers; and
an atmosphere introduction step, introducing atmosphere into the vacuum chamber.

8. The method of preparing the display panel according to claim 1, wherein the curing step comprises adopting an ultraviolet light curing method and/or a thermal curing method.

9. A display panel, prepared by the method according to claim 1.

10. The display panel according to claim 9, comprising:
the array substrate;
the color filter substrate disposed opposite to the array substrate;
the liquid crystal layer disposed between the array substrate and the color filter substrate; and
the primary sealant disposed between the array substrate and the color filter substrate and encircles the liquid crystal layer.
